(19) United States
(12) Patent Application Publication
(10) Pub. No.: US 2012/0266172 A1
(43) Pub. Date: Oct. 18, 2012

(54) APPARATUS AND METHOD FOR CONTROLLING A VIRTUAL MACHINE

(75) Inventors: Ji-Woong Byun, Seoul (KR); Jae-Wook Jeo, Suwon-si (KR); Seong-Jin Cho, Suwon-si (KR); Jong-Hyun Park, Suwon-si (KR); Sang-Chul Lee, Suwon-si (KR); Hae-II Hyun, Suwon-si (KR)

(73) Assignees: SUNGKYUNKWAN UNIVERSITY, Foundation for Corporate Collaboration, Suwon-si (KR); SAMSUNG ELECTRONICS CO., LTD., Suwon-si (KR)

(21) Appl. No.: 13/446,988

(22) Filed: Apr. 13, 2012

(30) Foreign Application Priority Data
Apr. 14, 2011 (KR) 10-2011-0034726

(51) Int. Cl. G06F 9/455

(52) U.S. Cl. 718/1

(57) ABSTRACT

The present disclosure relates to an apparatus for controlling a virtual machine in a device. The apparatus comprises a virtualization requesting part and a controlling part. The virtualization requesting part is configured to transmit a first instruction word for controlling the virtual machine to an independent virtualization apparatus. The controlling part is configured to execute an operation corresponding to a second instruction word received from the virtualization apparatus.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 14, 2011, and assigned Serial No. 10-2011-0034726, the entire disclosure of which is hereby incorporated by reference.

The present application is also related to U.S. patent application Ser. No. ______, filed on Apr. 13, 2012, and entitled “APPARATUS AND METHOD FOR CARRYING OUT A MIGRATION PROCESS OF A VIRTUAL MACHINE IN A DEVICE”. U.S. patent application Ser. No. ______ is assigned to the assignee of the present application and is hereby incorporated by reference into the present application as if fully set forth herein.

### TECHNICAL FIELD OF THE INVENTION

The present disclosure relates to a device for carrying out virtual technology, in particular a virtualization apparatus for controlling a virtual machine implemented in the device. In this case, a virtual apparatus means an apparatus to realize a system having a plurality of functions as one chip.

### BACKGROUND OF THE INVENTION

Recently, a portable terminal has been used by men and women of all ages as an essential good for modern life, and service providers and terminal manufacturers have been developing competitive products (or services) for distinguishing their businesses from other businesses. For example, the portable terminal has developed into a multimedia apparatus that can provide a phone book, a short message service (SMS), an Electronic (E)-mail, a morning call, a Motion Picture Expert Group Audio Layer-3 (MP3) player, a schedule management function, a digital camera, a multimedia message service (MMS) and a wireless internet service to be provided with and supply various services.

Recently, the function of the portable terminal has been improved and has used a multi-process structure for processing a great amount of work, supporting a plurality of software applications. For example, the portable terminal may use virtual technology to utilize a plurality of different processors. Virtual technology means that a plurality of operating systems are run in one portable terminal using virtualization layers (virtualization software) between the operating system and application program of the portable terminal. The processing rate of the virtualization layers may be assured if a virtual machine using the same instruction set architecture as that of the portable terminal is generated.

However, the process for converting the type of instruction word should be executed using a different binary type of instruction word in the virtualization layers if a virtual machine using a different instruction set architecture from that of the portable terminal is created. In this case, the process for converting the type of the instruction word may be executed with some software and may degrade a processing rate of the virtualization layers.

Therefore, an apparatus and a method for enhancing the processing rate of the virtual machine using a different instruction set architecture from that of the portable terminal for solving the above-mentioned problem is desirable.

### SUMMARY OF THE INVENTION

To address the above-discussed deficiencies of the prior art, it is an aspect of the present disclosure to provide an apparatus and method for controlling a virtual machine in a device using an apparatus independent from the device.

Another aspect of the present disclosure is to provide an apparatus and a method for enhancing the controlling rate of a virtual machine in a device using an apparatus independent from the device.

In accordance with an aspect of the present disclosure, an apparatus for controlling a virtual machine in a device is provided. The apparatus comprises a virtualization requesting part and a controlling part. The virtualization requesting part is configured to transmit a first instruction word for controlling the virtual machine to an independent virtualization apparatus. The controlling part is configured to execute an operation corresponding to a second instruction word received from the virtualization apparatus.

In accordance with another aspect of the present disclosure, an apparatus for controlling a virtual machine in a virtualization apparatus is provided that includes a virtual machine managing part and an instruction word processing part. The virtual machine managing part is configured, when an instruction word for controlling the virtual machine is received from a device, to determine whether a type of the virtual machine and a type of the device are the same type. The instruction word processing part is configured, when the type of the virtual machine is a different type from the type of the device, to convert the instruction word from the type of the device into the type of the virtual machine.

In accordance with another aspect of the present disclosure, a method for controlling a virtual machine in a device is provided. The method includes transmitting a first instruction word for controlling the virtual machine to an independent virtualization apparatus. An operation corresponding to a second instruction word received from the virtualization apparatus is executed.

In accordance with another aspect of the present disclosure, a method for controlling a virtual machine in a virtualization apparatus is provided. The method includes verifying the virtual machine to process an instruction word received from the device by checking whether a type of the virtual machine is a same type as a type of the device. When the type of the virtual machine is different from the type of the device, the instruction word is converted from the type of the device into the type of the virtual machine. The converted instruction word is transmitted to the virtual machine.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the team “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a virtualization system for carrying out the action procedure of a virtual machine according to the present disclosure;

FIG. 2 illustrates a procedure of a virtualization apparatus according to an exemplary embodiment of the present disclosure;

FIG. 3 illustrates a procedure for controlling a virtual machine in a device according to an exemplary embodiment of the present disclosure; and

FIG. 4 illustrates a procedure for controlling a virtual machine in a virtualization apparatus according to an exemplary embodiment of the present disclosure.

### DETAILED DESCRIPTION OF THE INVENTION

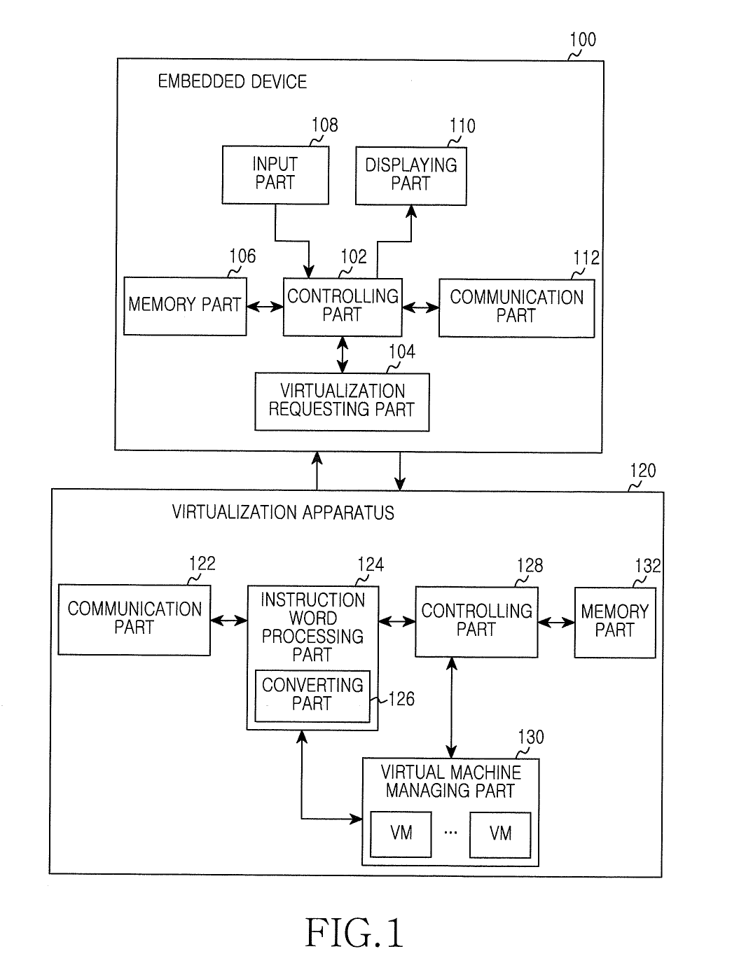

FIGS. 1 through 4, discussed below, and the various embodiments used to describe the principles of the present disclosure in this patent document are by way of illustration only and should not be construed in any way to limit the scope of the disclosure.

An apparatus and a method for enhancing capacity of a device for controlling the operation of a virtual machine using a virtualization apparatus independent from the device will be described below and the capacity may comprise a virtual machine generation, deletion, movement and the like according to the present disclosure. The apparatus independent from the device may control the transmission of an instruction word between the device and the virtual machine and may be mounted to a socket of the device.

FIG. 1 illustrates a structure of a virtualization system for carrying out the action procedure of a virtual machine according to the present disclosure. Referring to FIG. 1, a virtualization system may comprise an embedded device 100 and a virtualization apparatus 120. The embedded device 100 may comprise a controlling part 102, a virtualization requesting part 104, a memory part 106, an input part 108, a displaying part 110 and a communication part 112.

The controlling part 102 may control the overall operation of the device 100. For example, the controlling part 102 may execute process and control for voice communication and data communication if the device 100 is a mobile communication terminal and may decode an instruction word, carry out arithmetic or logic operation or process data if the device 100 is a personal computer. Also, the controlling part 102 may create a virtual machine using an independent virtualization apparatus 120 and run an operating system corresponding to an architecture different from its own architecture using the created virtual machine according to the present disclosure.

The virtualization requesting part 104 may request an instruction word to provide to the independent virtualization apparatus 120, transmit an instruction set architecture to the virtualization apparatus 120 and receive an instruction word supplied from the virtual machine. In this case, the virtualization requesting part 104 may comprise a socket for connecting to the independent virtualization apparatus 120.

The memory part 106 may include, for example, a Read Only Memory (ROM), a Random Access Memory (RAM), a Flash-ROM, and such. The ROM may store micro-code of a program for process and control of the controlling part 102 and the virtualization requesting part 104 and may also store various reference data. The RAM is working memory of the controlling part 102 and may store temporary data generated during the execution of the various programs. Also, the memory part 106 may store image data of an application executed through the virtual machine according to the present disclosure. The method described hereunder of the present invention may be provided as one or more instructions in one or more software modules stored in the storage device. The software modules may be executed by the controller.

The input part 108 may provide the controlling part 102 with key input data for operation of the device 100. The input part 108 may be a keyboard, a mouse and/or the like if the device 100 is a personal computer and the input part 108 may be a keypad comprising a plurality of numeral key buttons and menu buttons if the device 100 is a mobile communication terminal. For example, the input part 108 may provide the controlling part 102 with an instruction word for controlling the virtual machine (e.g., the generation, deletion, movement and the like of a virtual machine).

The displaying part 110 may display status information, characters, pictures, images and the like and display the operation process of the virtual machine according to the present disclosure. The displaying part 110 may utilize color liquid display apparatus (LCD), Active Mode Organic Light Emitting Diode (AMOLED), and such. The displaying part 110 may be used as an input device if it is applied to a touch input type of device 100 with a touch input device installed. A touch sensitive display, called as a touch screen, may be used as the display. Touch input may be performed via the touch sensitive display.

The communication part 112 may process the transmission and reception of signals to be input and output through a communication module, become a communication module for connection of a network or near field communication, and move the virtual machine to a peripheral device.

The virtualization apparatus 120 may comprise a communication part 122, an instruction word processing part 124, a controlling part 128, a virtual machine managing part 130 and a memory part 132. The instruction word processing part 124 may further comprise a converting part 126.

At first, the controlling part 128 of the virtualization apparatus 120 may control the virtual machine according to an instruction word received from the device 100 after it is mounted to the device 100. In this case, the controlling part 128 may generate a virtual machine, delete a virtual machine, or move a generated virtual machine to another device according to the instruction word of the device 100. Also, the controlling part 128 may convert the type of an instruction word to be exchanged between the device 100 and the virtual machine. That is, the controlling part 128 may convert an instruction word of the device 100 into a type of instruction word corresponding to the virtual machine and vice versa.

The communication part 122 may transmit an instruction word supplied from the device 100 or supplied to the device 100 and may comprise a socket for providing connections to the virtualization apparatus 120. That is, the virtualization apparatus 120 may be mounted to the device 100 or removed from the device 100 using the communication part 122.

The instruction word processing part 124 may transmit an instruction word received from the device 100 to the corresponding virtual machine and provide the device 100 with an instruction word received from the virtual machine. In this case, if the device 100 uses a type of instruction word different from the virtual machine, the instruction word processing part 124 may convert the instruction word of the device 100 into a virtual machine type of an instruction word and vice versa. The converting part 126 of the instruction word processing part 124 may convert the type of instruction word exchanged between the device 100 and the virtual machine according to the control of the instruction word processing part 124.

The virtual machine managing part 130 may create or delete a virtual machine and may move a created virtual machine to a peripheral device. Also, the virtual machine managing part 130 may monitor a created virtual machine and verify whether the virtual machine that is to receive the instruction word supplied from the device 100 uses the same type of instruction word as that of the device or not. That is, the virtual machine managing part 130 may determine whether or not the instruction word processing part 134 is to convert the instruction word.

The memory part 132 may store the data required for the operation of the virtualization apparatus 120 and may store instruction words supplied to and received from the virtual machine according to the present disclosure. The method described hereunder of the present invention may be provided as one or more instructions in one or more software modules stored in the storage device. The software modules may be executed by the controller.

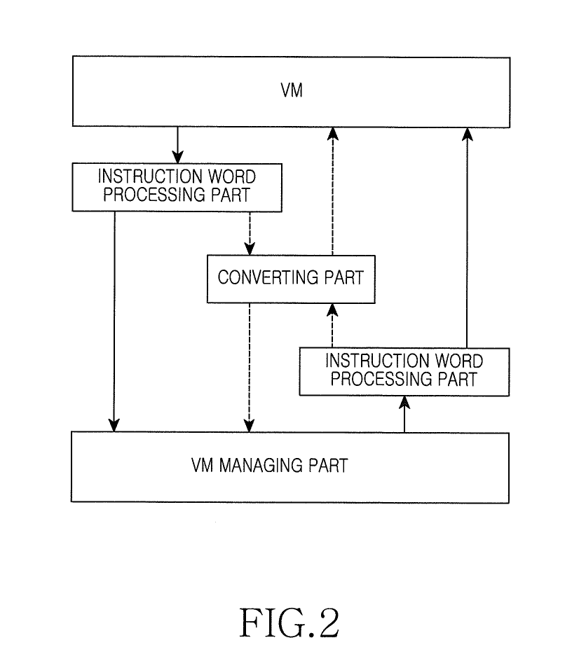

FIG. 2 illustrates a procedure of a virtual apparatus according to an exemplary embodiment of the present disclosure. Referring to FIG. 2, the process for converting the instruction word may be included in the operation process of the instruction word processing part of the virtualization apparatus.

At first, the virtualization apparatus may create a plurality of virtual machines by the virtual machine managing part and each of the virtual machines may use the same architecture as that of the device creating the device or a different architecture from that of the device. Hence, a virtual machine using the same architecture as that of the device may process an instruction word supplied from the device directly. But another virtual machine using architecture different from that of the device cannot process an instruction word supplied from the device directly.

For resolving the above-mentioned problem, the virtualization apparatus according to the present disclosure may convert an instruction word received from the device into a type of instruction word to be processed by the corresponding virtual machine and may supply the converted instruction word to the virtual machine. In addition, the virtualization apparatus may convert an instruction word received from the virtual machine corresponding to different architecture into a type of instruction word corresponding to the architecture of the device and may supply the converted instruction to the device.

That is, as shown in the FIG. 2, the virtual machine managing part of the virtualization apparatus may create a plurality of virtual machines according to the request of the device and monitor the virtual machines to check a virtual machine corresponding to the instruction word received from the device. In this case, the virtual machine managing part may provide the instruction word processing part with the received instruction word, and the instruction word processing part may check the architecture of the virtual machine corresponding to the instruction word to determine whether or not to perform the conversion process of the instruction word.

If it is determined that the conversion process of the instruction word is not to be performed, the instruction word processing part may provide the corresponding virtual machine with the instruction word received from the virtual machine managing part just as it is (as indicated as a solid line). If it is determined that the conversion process of instruction word is to be performed, the instruction word processing part may provide the corresponding virtual machine with the instruction word after the instruction word processing part converts the instruction word supplied from the virtual machine managing part into a type corresponding to the architecture of the virtual machine through the conversion part (as indicated as a dashed line).

Also, the instruction word processing part may process the conversion of an instruction word supplied to the device from the virtual machine. That is, if an instruction word is received from the virtual machine and it is determined that the conversion process is to be performed because the virtual machine to supply the instruction word uses architecture different from that of the device, the instruction word processing part may provide the virtual machine managing part with the instruction word after converting the received instruction word into a type corresponding to the device through the conversion part. Then, the virtual machine managing part may transmit the instruction word to the device through the communication part.

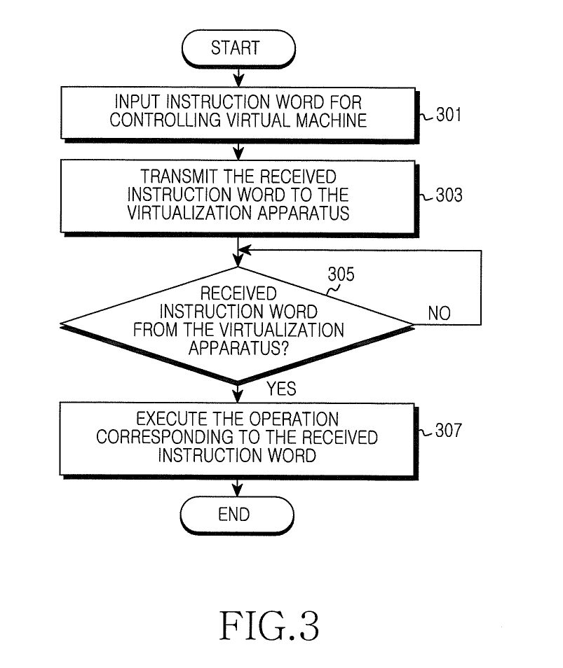

FIG. 3 illustrates a procedure for controlling a virtual machine in a device according to an exemplary embodiment of the present disclosure. Referring to FIG. 3, the device may mean a personal computer, a mobile communication terminal, a notebook or an embedded device. A virtual machine may be controlled using the device and the independent virtualization apparatus. In this case, the virtualization apparatus realizes the operation executed in the known virtualization layers as hardware.

At first, an instruction word for controlling the virtual machine may be input in the device by a user in step 301. In this case, the instruction word for controlling the virtual machine may comprise an instruction word to create a virtual machine, an instruction word to delete a virtual machine, an instruction word to move a virtual machine to another device, an instruction word to execute an application using a virtual machine and/or the like.

Then, the device may transmit the instruction word input in step 301 to the virtualization apparatus in step 303. In this case, the virtualization apparatus for controlling the virtual machine may be constituted as independent from the device. That is, if the virtualization apparatus is connected to the device (for example, by a socket of the device, a cable or the like), the virtual machine may be controlled in the device that does not have the virtualization layers.

Then, the device may check whether an instruction word is received from the virtualization apparatus in step 305. If it is determined in step 305 that an instruction word is not received, the device may execute the procedure of step 305 again. If it is determined in step 305 that the instruction word is received, the device may execute the operation corresponding to the received instruction word in step 307.

That is, in the known art for creating a virtual machine in a device, the virtual machine should be created through virtualization layers and the instruction word is converted in the virtualization layers, but the device according to the present disclosure may transmit the instruction word to the virtualization apparatus and then the virtualization apparatus may create the virtual machine and convert the instruction word.

Then, the device may terminate the algorithm.

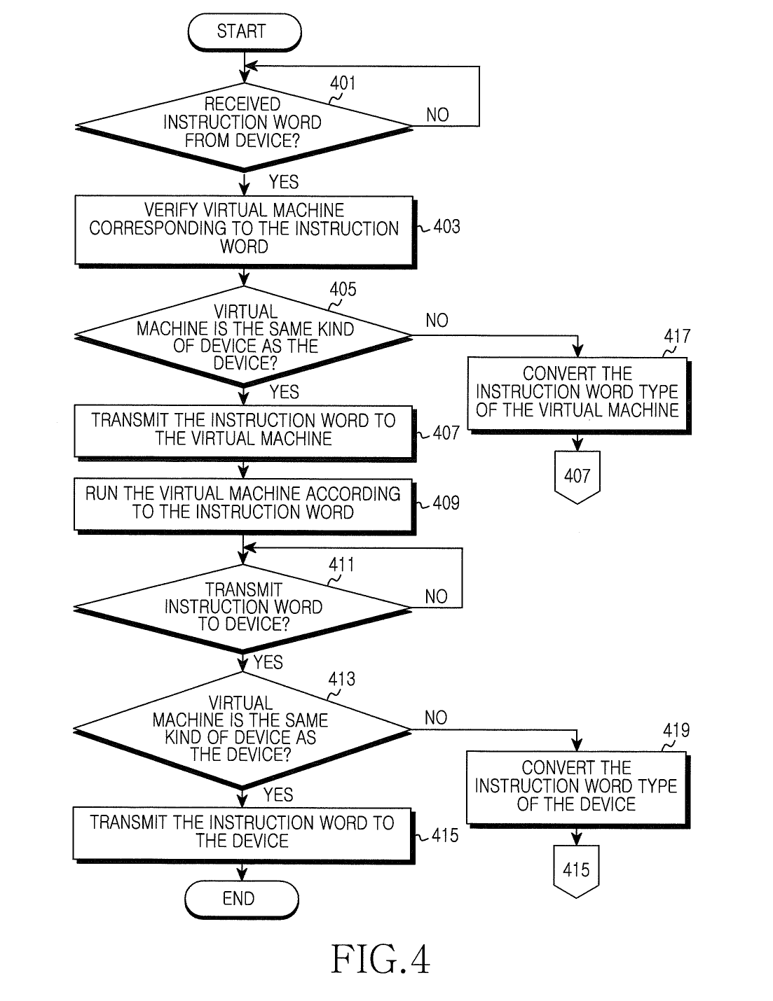

FIG. 4 illustrates a procedure for controlling a virtual machine in a virtualization apparatus according to an exemplary embodiment of the present disclosure. Referring to FIG. 4, the virtualization apparatus is mounted to the device and creates a virtual machine, which realizes the operation executed in the virtualization layers of the known device as hardware.

At first, the virtualization apparatus may check whether an instruction word for controlling a virtual machine is received from the device in step 401. In this case, the instruction word for controlling the virtual machine may comprise an instruction word for creating a virtual machine, an instruction word for deleting a virtual machine, an instruction word for moving a virtual machine to another device, an instruction word for operating an application using a virtual machine and the like.

If it is determined in step 401 that an instruction word is not received from the device, the virtualization apparatus may progress in a standing mode and may execute the procedure of step 401 again. If it is determined in step 401 that an instruction word is received from the device, the virtualization apparatus may progress to step 403 to verify a virtual machine corresponding to the received instruction word. In this case, the virtualization apparatus may determine a virtual machine among previously created virtual machines.

Then, the virtualization apparatus may progress to step 405 to check whether the virtual machine verified in step 403 is the same kind as the device that transmitted the instruction word. In this case, the same kind means to support the same kind of architecture as each other. If it is determined in step 405 that the two devices are the same kind, the device may progress to step 407 to transmit the received instruction word to the corresponding virtual machine because the device uses the same instruction set architecture as that of the virtual machine.

If it is determined in step 405 that the two devices are not the same kind, the device may progress to step 417 to convert the received instruction word into a type of instruction word corresponding to the architecture of the corresponding virtual machine and then progress to step 407 for transmitting the converted instruction word to the corresponding virtual machine because the device uses an instruction set architecture different from that of the virtual machine. Thus, the instruction set architecture of the device is converted into the type of the instruction set architecture corresponding to that of the virtual machine for processing the instruction word in the virtual machine.

The virtualization apparatus transmitting the above-mentioned instruction word to the virtual machine may progress to step 409 and may operate the virtual machine using the instruction word received from the device and then may progress to step 411 to determine whether to transmit an instruction word from the virtual machine to the device. In this case, operating the virtual machine in step 409 may comprise executing the operating system and running an application program (for example, a memo pad, a web browser, a game, a word program and the like) capable of being implemented in the operating system. Step 411 corresponds to a procedure for verifying, whether to transmit an instruction word received from the virtual machine to the device.

If it is determined in step 411 that transmission of an instruction word to the device is not to be carried out, the virtualization apparatus may carry out the procedure of step 411 again. If it is determined in step 411 that transmission of an instruction word to the device is to be carried out, the virtualization apparatus may progress to step 413 to verify whether the virtual machine to transmit the instruction word is the same kind as the device.

If it is determined in step 413 that the device is the same kind as the virtual machine, the virtualization apparatus may progress to step 415 to transmit the instruction word received from the virtual machine to the device. If it is determined in step 413 that the device is not the same kind as the virtual machine, the virtualization apparatus may progress to step 419 to convert the instruction word received from the virtual machine into the type of instruction word corresponding to the device and then progress to step 415 for transmitting the converted instruction word to the device.

Then, the virtualization apparatus may terminate the algorithm.

Also, computer readable storage medium storing one or more programs, the one or more programs comprising instructions, which when executed by a portable electronic device with a touch-sensitive display, cause the portable electronic device to perform a method comprising, collecting log information comprising the daily life information from at least one electronic device, analyzing the log information collected and deciding at least one topic representing the daily life information, generating at least one sentence representing the daily life information using the at least one topic decided, and displaying the generated at least one sentence.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described in detail, the present disclosure relates to an apparatus and a method for improving the controlling rate of the virtual machine and can enhance the conversion rate of the instruction word between the device and the virtual machine using an apparatus independent from the device. In this case, the apparatus independent from the device may be mounted to and removed from the device as an apparatus for carrying out the function of the virtualization layers to process the virtual technology.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for controlling a virtual machine in a device, the apparatus comprising:
a virtualization requesting part configured to transmit a first instruction word for controlling the virtual machine to an independent virtualization apparatus; and
a controlling part configured to execute an operation corresponding to a second instruction word received from the virtualization apparatus.

2. The apparatus of claim 1, wherein the first instruction word for controlling the virtual machine comprises at least one selected from a group consisting of an instruction word for creating the virtual machine, an instruction word for deleting the virtual machine, an instruction word for moving the virtual machine to a second device and an instruction word for running an application using the virtual machine.

3. The apparatus of claim 1, wherein the virtualization apparatus is configured to provide an operation corresponding to virtualization layers for creating and controlling the virtual machine as a form of hardware, and wherein a program corresponding to the virtualization layers is not installed in the device.

4. An apparatus for controlling a virtual machine in a virtualization apparatus, the apparatus comprising:
a virtual machine managing part configured, when an instruction word for controlling the virtual machine is received from a device, to determine whether a type of the virtual machine and a type of the device are the same type; and
an instruction word processing part configured, when the type of the virtual machine is a different type from the type of the device, to convert the instruction word from the type of the device into the type of the virtual machine.

5. The apparatus of claim 4, wherein the instruction word processing part is further configured, when the type of the virtual machine is the same type as the type of the device, to transmit the instruction word as received to the virtual machine.

6. The apparatus of claim 4, wherein the type of the device corresponds to an instruction set architecture of the device and the type of the virtual machine corresponds to an instruction set architecture of the virtual machine.

7. The apparatus of claim 4, wherein the virtualization apparatus is configured to provide an operation corresponding to virtualization layers for creating and controlling the virtual machine as a form of hardware.

8. The apparatus of claim 4,
wherein the virtual machine managing part is further configured, when a second instruction word is received from the virtual machine for the device, to determine whether the type of the virtual machine and the type of the device are the same type; and
wherein the instruction word processing part is further configured, when the type of the virtual machine is a different type from the type of the device, to convert the second instruction word from the type of the virtual machine into the type of the device and transmit the converted second instruction word to the device and, when the type of the virtual machine is the same type as the type of the device, to transmit the second instruction word as received from the virtual machine to the device.

9. A method for controlling a virtual machine in a device, the method comprising:
transmitting a first instruction word for controlling the virtual machine to an independent virtualization apparatus; and
executing an operation corresponding to a second instruction word received from the virtualization apparatus.

10. The method of claim 9, wherein the first instruction word for controlling the virtual machine comprises at least one selected from a group consisting of an instruction word for creating the virtual machine, an instruction word for deleting the virtual machine, an instruction word for moving the virtual machine to a second device and an instruction word for running an application using the virtual machine.

11. The method of claim 9, wherein the virtualization apparatus is configured to provide an operation corresponding to virtualization layers for creating and controlling the virtual machine as a form of hardware, and wherein a program corresponding to the virtualization layers is not installed in the device.

12. A method for controlling a virtual machine in a virtualization apparatus, the method comprising:
verifying the virtual machine to process an instruction word received from the device by checking whether a type of the virtual machine is a same type as a type of the device; and
when the type of the virtual machine is different from the type of the device, converting the instruction word from the type of the device into the type of the virtual machine and transmitting the converted instruction word to the virtual machine.

13. The method of claim 12, the method further comprising, when the type of the virtual machine is the same as the type of the device, transmitting the instruction word as received to the virtual machine.

14. The method of claim 12, wherein checking whether the type of the virtual machine is the same type as the type of the device comprises checking whether the device uses a same instruction set architecture as an instruction set architecture used by the virtual machine.

15. The method of claim 12, wherein the virtualization apparatus is configured to realize an operation corresponding to virtualization layers for creating and controlling the virtual machine as a form of hardware.

16. The method of claim 12, further comprising:
when a second instruction word is received from the virtual machine for the device, checking whether the type of the virtual machine is the same type as the type of the device;
when the type of the virtual machine is different from the type of the device, converting the second instruction word from the type of the virtual machine into the type of the device and transmitting the converted second instruction word to the device; and
when the type of the virtual machine is the same as the type of the device, transmitting the second instruction word as received from the virtual machine to the device.

17. The apparatus of claim 1, wherein the independent virtualization apparatus is connected to the device using either socket connection or cable connection.
